(19) United States
(12) Patent Application Publication
(10) Pub. No.: US 2011/0217862 A1
(43) Pub. Date: Sep. 8, 2011

(54) CONNECTOR STRUCTURE FOR HIGH-FREQUENCY TRANSMISSION LINES

(76) Inventor: Shou-Ying WANG, Taipei City (TW)

(21) Appl. No.: 12/761,986

(22) Filed: Apr. 16, 2010

(30) Foreign Application Priority Data
Mar. 5, 2010 (TW) 099203985

(51) Int. Cl. H01R 13/625

(52) U.S. Cl. 439/332

(57) ABSTRACT

A connector structure for high-frequency transmission lines comprises a locking sleeve used for receiving the connector of a signal cable therein for signal transmission, and is characterized in that: the locking sleeve comprises a hollow part and the hollow part is disposed in the locking sleeve, where the hollow part includes a hollow metal piece, so that when connected into the locking sleeve, the connector of the signal cable is inserted through the hollow metal piece of the hollow part.

### TECHNICAL FIELD

The present invention relates to a connector structure for high-frequency transmission lines, whose structure is simple and whose electrical characteristics are improved to obtain high-transmission efficiency and low-reflection effects.

### BACKGROUND

In modern life changing with each passing day, the average living standard is gradually improved. With this improvement, people are more particular about their material enjoyment and accordingly many high-technology products are invented. Some connectors are required to utilize these high-technology products in order to transmit signals and among the connectors the most well known is Bayonet Neil-Concelman (BNC) connector.

Typically, the bandwidth of the BNC connector is between 0 to 3 GHz; the resistance thereof is between 50 to 75 Ohm; and the insertion loss thereof is about 0.2 dB. BNC connectors are widely applied in different field; for example, they can be used in following items: apparatuses for radio-frequency signal transmission, for analog/video signal transmission, and for radio antenna data transmission; aircraft electronic apparatuses; and consumer electronic apparatuses. Therefore, BNC connectors are not only used for the computers in the early times, but also applicable for the industrial equipments, electronic test equipments, or common monitors in the present times. A BNC connector has a male connecting part and a female connecting part. The male connecting part of the BNC connector is located at the end where signals is input and is connected with a coaxial cable. The female connecting part of the BNC connector is connected to an apparatus receiving the signals. The input video signals can be transmitted into and processed by the apparatus via the male and female connecting parts of the BNC connectors and a video signal transmission line successively. To put it simply, a BNC connector is used as an interface between a coaxial cable and various apparatuses or equipments.

However, when present 75-Ohm system is required to be expanded to have bandwidth of 4.5 G, the electrical characteristics of present BNC connectors are not good enough, which may further affected the transmission efficiency. Therefore, in order to overcome above shortcomings, inventor had the motive to study and develop the present invention by modifying the BNC connector structure capable of providing high-transmission efficiency and low reflection effect.

### SUMMARY OF THE INVENTION

An object of the present invention is to provide a connector structure for high-frequency transmission lines, which has simple structure and has improved electrical characteristics so as to obtain high-transmission efficiency and low reflection effect.

In order to achieve above object, the present invention provides a connector structure for high-frequency transmission lines comprising a locking sleeve used for receiving the connector of a signal cable therein for signal transmission, and characterized in that: the locking sleeve comprises a hollow part and the hollow part is disposed in the locking sleeve, where the hollow part includes a hollow metal piece, so that when connected into the locking sleeve, the connector of the signal cable is inserted through the hollow metal piece of the hollow part.

In practice, the hollow part is in the shape of a ring.

In practice, the hollow part includes the hollow metal piece and a hollow plastic piece. The hollow metal piece and the hollow plastic piece are superimposed and connected with each other. Or, the hollow metal piece is covered by the hollow plastic piece.

In practice, the hollow part is formed integratedly into the locking sleeve.

The following detailed description, given by way of examples or embodiments, will best be understood in conjunction with the accompanying drawings.

### BRIEF DESCRIPTION OF THE DRAWINGS

FIG. 1 is a perspective view of an embodiment of a connector structure of the present invention.

FIG. 2 is an exploded perspective view of the embodiment of the connector structure of the present invention.

FIG. 3 is a perspective view of the embodiment of the present invention, where the connector of a signal cable is connected to the hollow part.

FIG. 4 is an exploded perspective view of another embodiment of a connector structure of the present invention.

FIG. 5 is a schematic view of the present invention showing another type of an assembled hollow part.

FIG. 6 is a cross sectional view of FIG. 5.

### DETAILED DESCRIPTION

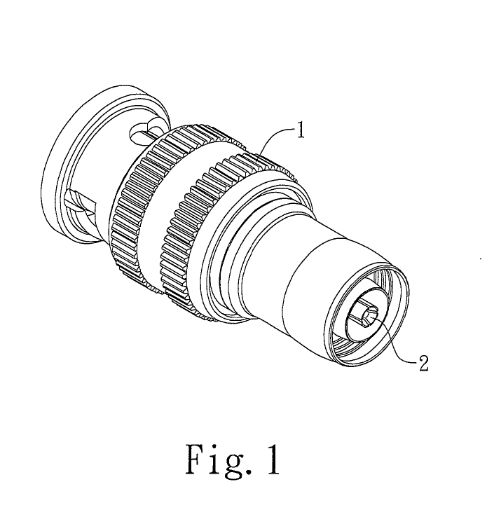

Please refer to FIGS. 1 to 3 showing an embodiment of a connector structure for high-frequency transmission lines according to the present invention.

The present invention provides a connector structure for high-frequency transmission lines, which comprising a locking sleeve 1 used for receiving the connector 2 of a signal cable therein for signal transmission. The locking sleeve 1 comprises a hollow part 10 and the hollow part 10 is in the shape of a ring and is disposed in the locking sleeve 1. The hollow part 10 includes a hollow metal piece 11, so that when connected into the locking sleeve 1, the connector 2 of the signal cable is inserted through the hollow metal piece 11 of the hollow part 10.

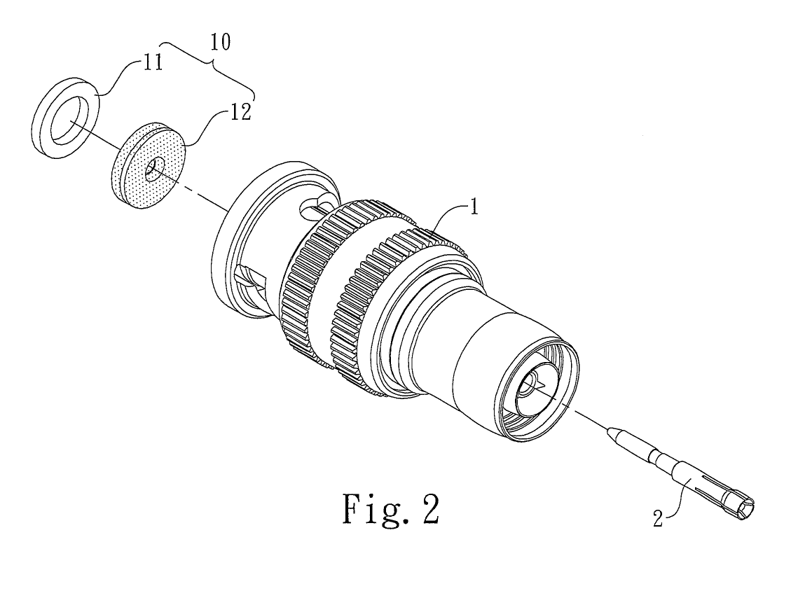

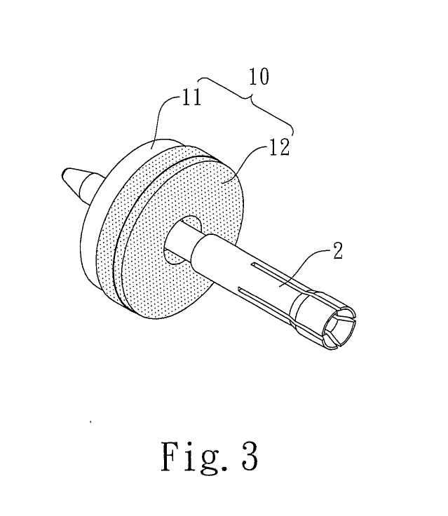

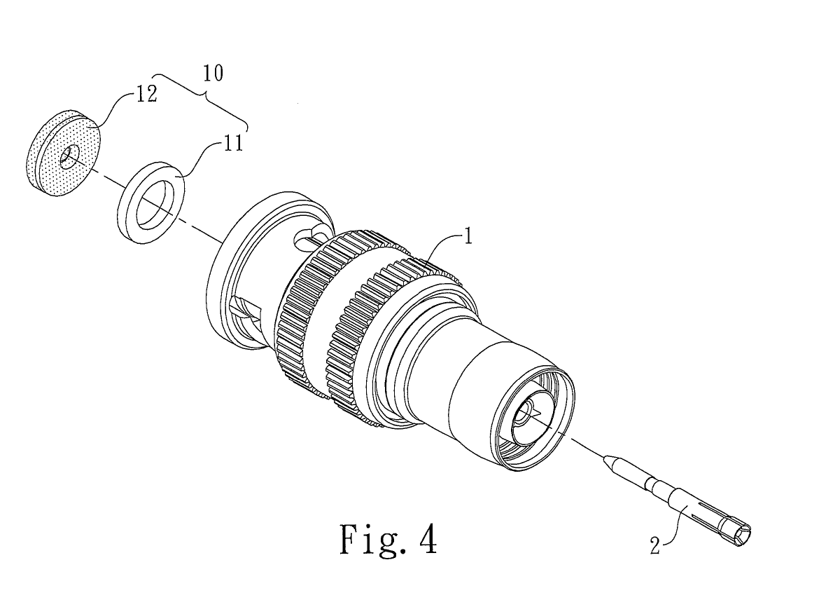

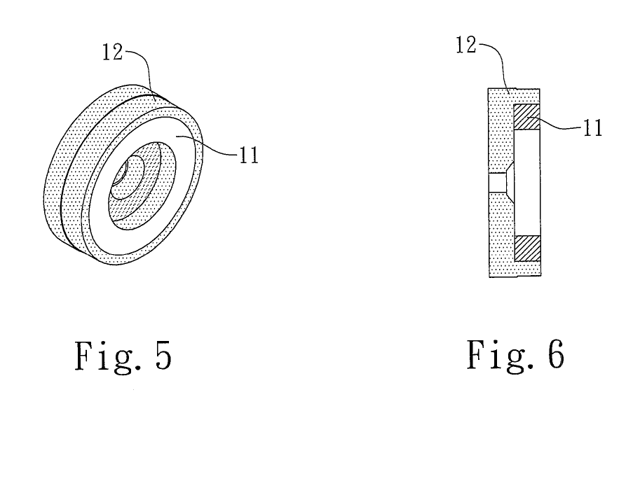

In practice, the hollow part 10 can be formed integratedly into the locking sleeve 1. Alternatively, as referring to FIGS. 2 and 3, the hollow part 10 can be formed by combining the hollow metal piece 11 and a hollow plastic piece 12. The hollow metal piece 11 and the hollow plastic piece 12 are superimposed and connected with each other. Therefore, when the connector 2 of a signal cable is inserted into the locking sleeve 1, it passes successively through the hollow plastic piece 12 and the hollow metal piece 11 of the hollow part 10, or successively through the hollow metal piece 11 and the hollow plastic piece 12 of the hollow part 10 (as shown in FIG. 4). Consequently, the connector 2 of the signal cable is inserted through the hollow part 10. Moreover, as shown in FIGS. 5 and 6, the hollow metal piece 11 can be covered by the hollow plastic piece 12. By this way, after the connector 2 of the signal cable is inserted through the hollow part 10, it is inserted through the hollow metal piece 11.

Therefore, when the connector 2 of the signal cable is inserted through the hollow metal piece 11 and connected with the signal cable, the electrical characteristics can be improved to obtain high-transmission efficiency and low reflection effect.

As disclosed in the above description and attached drawings, the present invention can provide a connector structure for high-frequency transmission lines. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

1. A connector structure for high-frequency transmission lines, comprising a locking sleeve used for receiving the connector of a signal cable therein for signal transmission, and characterized in that:
the locking sleeve comprises a hollow part in the locking sleeve for the connector of the signal cable to pass through the hollow part, wherein where the hollow part includes a hollow metal piece and the connector of the signal cable is inserted through the hollow metal piece of the hollow part when connected into the locking sleeve.

2. The connector structure for high-frequency transmission lines as claimed in claim 1, wherein the hollow part includes the hollow metal piece and a hollow plastic piece.

3. The connector structure for high-frequency transmission lines as claimed in claim 2, wherein the hollow metal piece and the hollow plastic piece are superimposed and connected with each other.

4. The connector structure for high-frequency transmission lines as claimed in claim 2, wherein the hollow metal piece is covered by the hollow plastic piece.

5. The connector structure for high-frequency transmission lines as claimed in claim 1, wherein the hollow part is in the shape of a ring.

6. The connector structure for high-frequency transmission lines as claimed in claim 1, wherein the hollow part is formed integratedly into the locking sleeve.
